(19) United States
(12) Patent Application Publication
(10) Pub. No.: US 2016/0001775 A1
(43) Pub. Date: Jan. 7, 2016

(54) Method for ascertaining an emergency trajectory and method for partially automated or automated driving of an ego-vehicle

(71) Applicant: Robert Bosch GmbH, Stuttgart (DE)

(72) Inventors: Ulf Wilhelm, Rutsheim (DE); Sybille Eisele, Hessigheim (DE); Carsten Hasberg, Ilsfeld-Auenstein (DE); Oliver Pink, Stuttgart (DE); Michael Helmle, Esslingen (DE)

(21) Appl. No.: 14/754,963

(22) Filed: Jun. 30, 2015

(30) Foreign Application Priority Data
Jul. 3, 2014 (DE) 10 2014 212 898.6

(51) Int. Cl. B60W 30/095; B60Q 9/00

(52) U.S. Cl. CPC B60W 30/0956; B60Q 9/008; B60W 2550/20

(57) ABSTRACT

A method for ascertaining at least one emergency trajectory of an ego-vehicle using an assistance system, in particular a driver assistance system of the ego-vehicle, and/or an automatic driving function, upon detection of an imminent collision of the ego-vehicle, at least one emergency trajectory of the ego-vehicle being ascertained by the assistance system or the automatic driving function under consideration of at least one other trajectory of at least one other object which is different from the ego-vehicle. Also described is a computer program or a computer program product, a computer unit or a processing unit, and a safety device, in particular having an assistance system and/or an automatic driving function for a vehicle, including a motor vehicle.

### RELATED APPLICATION INFORMATION

The present application claims priority to and the benefit of German patent application no. 10 2014 212 898.6, which was filed in Germany on Jul. 3, 2014, the disclosure of which is incorporated herein by reference.

### FIELD OF THE INVENTION

The present invention relates to a method for ascertaining at least one emergency trajectory for an ego-vehicle using an assistance system, in particular a driver assistance system of the ego-vehicle, and/or an automatic driving function. The present invention Furthermore relates to a method for partially automated or automated driving of an ego-vehicle, upon detecting an imminent collision of the ego-vehicle, the method according to the present invention being initially carried out for ascertaining the at least one emergency trajectory of the ego-vehicle. The present invention furthermore relates to a computer program or a computer program product, a computer unit or a processing unit, and a safety device for a vehicle, which may be a motor vehicle.

### BACKGROUND INFORMATION

The active safety is a focal point for the development of present and also future motor vehicle systems. Known safety and driver assistance systems—subsequently also designated as assistance systems—in the area of active safety of the motor vehicle passengers, i.e., for accident prevention for the motor vehicle in question, are, for example, electronic power steering (EPS), electronic stability program (ESP) for stabilizing the motor vehicle by brake interventions in threshold areas of driving dynamics, and vehicle dynamic management (VDM) as an expansion of ESP by additional steering and/or acceleration interventions. Driver assistance systems, for example, adaptive cruise control (ACC), an automatic emergency braking system, or a lane departure warning system are also to be cited.

The rate of equipment of driver assistance systems in today's vehicles increases steadily; in the meantime, driver assistance systems are also being installed in medium-class vehicles. The driver assistances systems will be further developed up to automated driving and additionally serve to relieve a vehicle driver of driving tasks and thereby contribute to reducing the number and severity of accidents. Due to an assistance or automated driving —subsequently designated as automatic driving function—a probability of being involved in a collision is namely reduced; however, culpable and unpredictable collisions may still occur due to other or different road users, for example, vehicles not equipped with an assistance system or an automatic driving function.

### SUMMARY OF THE INVENTION

It is an object of the present invention to provide a method with which it is possible to lower a probability of a collision for an ego-vehicle and/or to reduce the consequences with respect to the severity of injuries and/or property damages in an unavoidable collision. The method according to the present invention shall thereby be able to cooperate with an already existing system, for example, a safety device, in particular a (driver) assistance system and/or an automatic driving function, among others, in order to increase its effectiveness. The method according to the present invention shall function safely and reliably and also be inexpensive in its implementation. For this purpose, the method shall be implementable with a sensor system and/or actuators already installed in a motor vehicle. Furthermore, an object of the present invention is to provide a computer program or a computer program product, a computer unit or a processing unit, and a safety device for a vehicle, which may be a motor vehicle.

The object of the present invention may be achieved by a method for ascertaining at least one emergency trajectory of an ego-vehicle using an assistance system, in particular a driver assistance system of the ego-vehicle, and/or an automatic driving function as described herein; by a method for partially automated or for automated driving of an ego-vehicle as described herein; with the aid of a computer program or a computer program product as described herein 10; with the aid of a computer unit or a processing unit as described herein; and with the aid of a safety device as described herein. Advantageous refinements, additional features, and or advantages of the present invention arise from the further descriptions herein and/or from the following description.

In the method according to the present invention, upon detecting an imminent collision of an ego-vehicle using the assistance system or the automatic driving function, the at least one emergency or evasion trajectory of the ego-vehicle is ascertained under consideration of at least one other trajectory of at least one other object different from the ego-vehicle. The assistance system may be an assistance system of the ego-vehicle or an external assistance system relative to the ego-vehicle, in particular an infrastructure-based assistance system. The other object may be, for example, another vehicle, in particular another motor vehicle, another road user, or a stationary yet moveable, or fixed other object in the surroundings of the ego-vehicle.

The following should be understood here with regard to an imminent collision. If the ego-vehicle were, due to the assistance system or the automatic driving function, not in a position to bring itself, i.e., the ego-vehicle, out of a danger zone, then the collision would occur with high or preponderant likelihood. This means that without a steering or control function by the assistance system or the automatic driving function, the collision happens to the ego-vehicle with high or preponderant likelihood. This means that if the vehicle driver makes essentially all decisions for the ego-vehicle, then this accident also occurs with high or preponderant likelihood. The higher or preponderance of probability may be selected in this case and amounts to for example 20%-30%, 30%-40%, 40%-50%, 50%-60%, or over 60%.

The emergency trajectory is characterized in that this differs from a collision-prone driving trajectory of the ego-vehicle, if necessary, only in a spatial and/or temporal segment, i.e., the emergency trajectory is always non-identical with an original or a projected driving trajectory of the ego-vehicle. The original or the projected driving trajectory results in an accident of the ego-vehicle at the above-listed probability. Furthermore, the emergency trajectory differs from an evasion trajectory primarily in that on the one hand the ego-vehicle is not the cause of the accident and on the other hand this accident occurs with the above-listed probability. This means that the accident to be avoided may be based on a mistake by another or different road user.

According to the present invention, the at least one emergency trajectory may be, if necessary, successively ascertained from an array of emergency trajectories or an emergency trajectory space of the ego-vehicle. Furthermore, the at least one other trajectory may be ascertained from an array of other trajectories or another trajectory space of the relevant other object, or the at least one other trajectory may be an array of other trajectories or another trajectory space. The relevant trajectory space may also be designated as a phase space or a state space.

A trajectory is to be understood as a time-dependent progression (point, line, curve) of an object in a stationary (for example, with regard to a possible collision or accident point of the ego-vehicle) or a moving reference system (for example, the ego-vehicle itself). An object in the reference system, stationary with regard to a spatial origin of the reference system, corresponds only to a temporal movement in the reference system (point in the space, line in time), if the object in the reference system moves; this thus corresponds to a spatial-temporal movement in the reference system (line, curve in space time). This means that a trajectory is a purely temporal and/or a space-time track in a stationary or a moved reference system and is composed thereby.

According to the present invention, in the case of an unavoidable collision, the emergency trajectory is to be ascertained in such a way that first of all probably no or only minor physical injuries occur and only secondarily do probably no or only minor property damages occur. Temporally during or chronologically after the ascertainment of the at least one emergency trajectory, an emergency trajectory may be selected by the assistance system or the automated driving function and output to the vehicle driver and/or an automatic driving module of the automatic driving function. In this case, the selected emergency trajectory may be output as an established emergency trajectory, or the emergency trajectory may be changed during the traveling or a completion of an emergency trajectory, corrected by segments, (successively) supplemented, and/or newly calculated, i.e., ascertained.

The imminent collision of the ego-vehicle may be detected by a situation analysis within the scope of a surroundings model of the ego-vehicle, whereby the surroundings model considers in particular a piece of information from a surroundings sensor system of the ego-vehicle, a Car-to-X communication of the ego-vehicle, a navigation of the ego-vehicle, and/or a traffic report. A Car-to-X communication may be understood to be, for example, a car-to-car communication, a car-to-infrastructure and/or an infrastructure-to-car communication. This means that this offers the ego-vehicle the chance to determine, i.e., to ascertain, an ego-trajectory with a low or what may be a low risk by using external and/or internal information under consideration of possible other trajectories of other objects, such as those of other road users.

According to the present invention, data may be considered for the surroundings model and/or data may be considered from the situation analysis within the scope of the surroundings model for ascertaining the emergency trajectory. Furthermore, an evaluation may be carried out of the data from the other object(s). In addition, a situation analysis may be carried out within the scope of a passenger model; through the use of this, potential dangers to a passenger of the ego-vehicle are considered. In addition, a situation analysis may be carried out within the scope of a passenger model in order to consider potential dangers for passengers in the motor vehicle which may be a potential other party in the accident. The information for this may be transmitted, for example, via Car-to-X. Moreover, a control of the ego-vehicle to be expected during the presently prevailing conditions may be considered. A guaranteed and/or estimated behavior of another road user may be considered and/or a risk of an end position of the ego-vehicle to be expected may be considered chronologically after the traveled emergency trajectory.

According to the present invention, an expanded search field, for example, by circumventing conventional traffic rules and/or rules of conduct, may be used for the emergency trajectory during ascertainment of the at least one emergency trajectory. Upon carrying out the method according to the present invention, a warning may be output by the ego-vehicle about the imminent collision to the other road user. The warning may be visual, acoustic, and/or output via radio. Furthermore, the method may consider a piece of country-specific information. According to the present invention, data from a damage model may be considered for ascertaining the emergency trajectory.

With regard to the method according to the present invention for partially automated or automated driving of an ego-vehicle, the above method is initially carried out upon detection of the imminent collision of the ego-vehicle. Furthermore, a warning is output to the vehicle driver of the ego-vehicle by the assistance system or the automatic driving function, whereby an emergency trajectory is output as a trajectory to be traveled, for example, an evasion trajectory, and/or an intervention is carried out in/on the ego-vehicle by the assistance system or the automatic driving function in such a way that the ego-vehicle is forced for this purpose to travel or to follow an emergency trajectory. An emergency trajectory which has been successfully negotiated may be designated as a traveled evasion trajectory, whereby an accident occurred without a substantial and/or original involvement of the ego-vehicle.

According to the present invention, the emergency trajectory may be haptically, visually, and/or acoustically output to the vehicle driver of the ego-vehicle. Furthermore, the intervention on the ego-vehicle may be an intervention on/in the chassis, in particular a steering, brake, and/or damper intervention, and/or an intervention on/in the drivetrain, in particular an engine and/or transmission intervention. It is possible to configure the method in such a way that the intervention on the ego-vehicle must be confirmed by the vehicle driver or may be negated by the vehicle driver. Chronologically after traveling the emergency trajectory, the ego-vehicle may be partially automated by the vehicle driver and/or automatically brought into a safe position. In addition, chronologically after traveling the emergency trajectory, a prompt for taking over the vehicle may be issued to the vehicle driver of the ego-vehicle.

The present invention is implementable as a computer program, for example, in a computer unit according to the present invention or a processing device according to the present invention. This means that a computer program product according to the present invention, for example, a computer program on a data carrier, includes program code, which includes a program code arrangement for carrying out or executing the method according to the present invention. For this purpose, the computer program may be executed on a (micro)processor or a (micro or mini) computer and/or stored on a data carrier or a digital memory medium.

This type of machine- or computer readable data carrier or a digital memory medium of this type may be, for example, a hard disk, a ROM-, EPROM-, EEPROM-, or a flash memory, a memory chip, a diskette, a CD-ROM, a DVD, or a Blu-Ray disk. Furthermore, the computer program may be stored in the form of firmware. For this purpose, the computer program may interact with electronically available or readable (if necessary, control/regulating) signals, for example information from a sensor, an evaluation unit, and/or an actuator, in a programmable processor or computer unit or a corresponding system in such a way that one specific embodiment of the method according to the present invention may be carried out or executed.

The computer unit according to the present invention may be configured as an arithmetic logic unit or as a subunit of the processing unit according to the present invention. The processing unit is configured for example as an electronic arithmetic unit, as a microcontroller or a processor, as a (micro or mini) computer, a control unit or a control device, or as another unit/apparatus or a device, which may naturally carry out or execute other functions as well. Furthermore, the computer unit or the processing unit may include the computer program product according to the present invention.

According to the present invention, the method may be used or applied in a safety device, in particular in a driver assistance system of a vehicle and/or an automatic driving function of the vehicle, to increase traffic safety. Thus, the present invention may be carried out, if necessary, partially with the aid of a chassis unit, in particular a steering, brake, and/or damper controller/regulator, and/or, if necessary, partially with the aid of a drivetrain unit, in particular an engine (for example, an acceleration intervention) and/or transmission controller/regulator, of the ego-vehicle.

The safety device according to the present invention is configured in such a way that as a result the method according to the present invention may be carried out for ascertaining an emergency trajectory of a vehicle and/or the method may be carried out for partially automated or for automated driving of a vehicle. Furthermore, the safety device may include a computer program according to the present invention or a computer program product according to the present invention, and/or a computer unit according to the present invention or a processing unit according to the present invention.

During an imminent collision or accident situation, most vehicle drivers are too overwhelmed to detect the entire situation and to correctly estimate reactions of other road users in order to derive an inherent reaction with a low or indeed a preferably low risk. In particular, it is not possible for every vehicle driver to consider the experience of accident experts with regard to a damage model in fractions of seconds and to then convert this systematically into an emergency trajectory or a multitude of possible emergency trajectories.

The present invention overcomes these problems and offers the ego-vehicle and the passengers thereof as well as other road users a significantly improved protection. Furthermore, according to the present invention, an already existing method for increasing active and/or passive safety may be expanded or supplemented by the method according to the present invention. The method according to the present invention may function safely, robustly, and reliably, and its implementation is cost efficient, since appropriate sensors, evaluation units, and/or actuators are already present in a motor vehicle with automated functions.

### BRIEF DESCRIPTION OF THE FIGURES

FIG. 1 shows, in part, a collision detection module 20 of the present system and method.

FIG. 2 shows, in part, an emergency trajectory module 30 of the present system and method.

FIG. 3 shows, in part, a passenger module 40 of the present system and method.

FIG. 4 shows, in part, an evaluation module 50 of the present system and method.

FIG. 5 shows, in part, a control of the ego-vehicle module 60 of the present system and method.

### DETAILED DESCRIPTION

The present invention is explained in greater detail based on exemplary embodiments with reference to the appended schematic drawings. Elements or components which have an identical, univocal, or analogous design and/or function are designated in the description and in the figures of the drawing with the same reference numerals. All explained features may be used not only in the indicated combination(s), but also in another combination or other combinations without departing from the scope of the present invention.

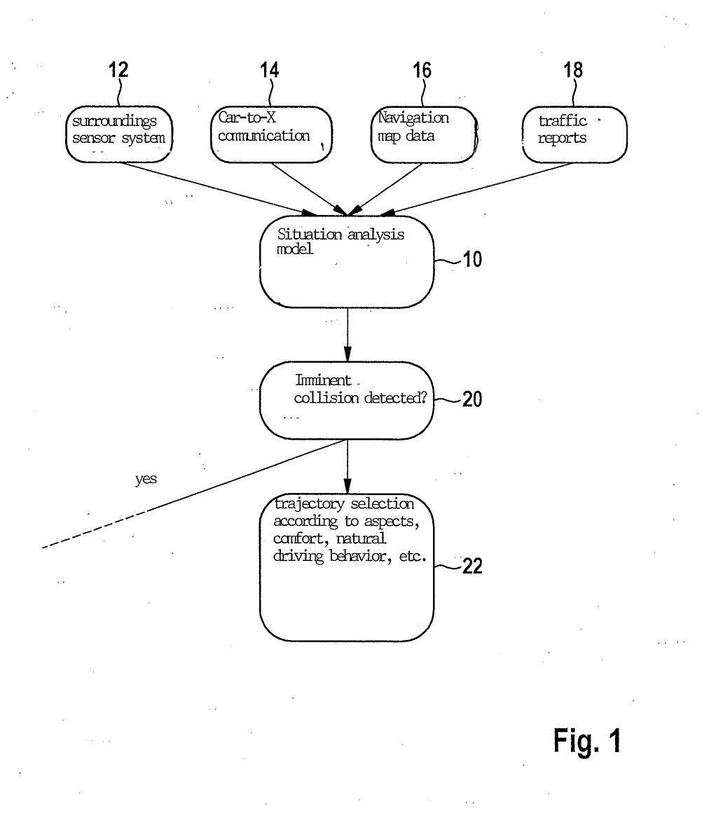

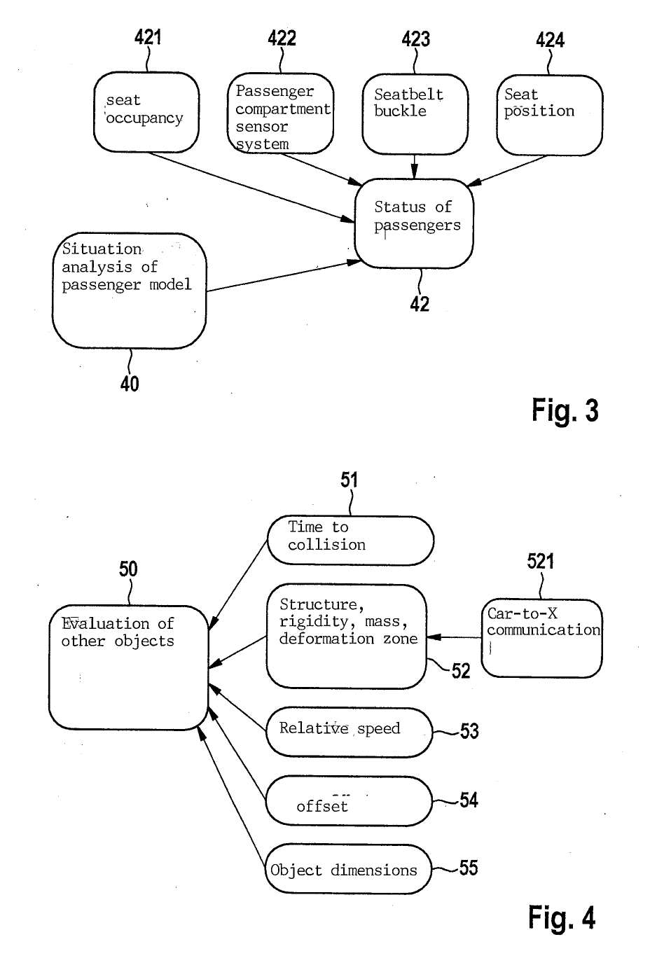

The figures (FIGS. 1 through 5) of the drawing show a block diagram or flow chart of one specific embodiment of the method according to the present invention for partially automated or automated driving of an ego-vehicle, whereby upon detecting an imminent collision of the ego-vehicle, a method according to the present invention for ascertaining at least one emergency or evasion trajectory of an ego vehicle is carried out using an assistance system, in particular a driver assistance system of the ego-vehicle, and/or an automatic driving function. The latter method ascertains the possible emergency trajectory or trajectories and selects if necessary a suitable emergency trajectory and proposes this to a vehicle driver (assistance system) and/or, if necessary, intervenes with the ego-vehicle while completely circumventing the vehicle driver (automatic driving function).

According to the present invention, a collision detection (Module 20) is initially carried out in the assistance system, in particular the driver assistance system, of the ego-vehicle and is explained in greater detail based on FIG. 1. The collision detection has a surroundings model module (Module 10) as a decision basis, in which a situation analysis for the ego-vehicle is carried out in relation to whether a collision is imminent or threatens or not. This is decided in Module 20. If Module 20 does not detect a collision, then the method continues in Module 22, whereby a selection of a trajectory for the ego-vehicle is selectable according to considerations like comfort, a natural driving behavior, etc. This trajectory may also be selected completely autonomously by the vehicle driver or with an aid (driver assistance system). If Module 20 detects an imminent collision, then the method continues in Module 30.

Possible components for the situation analysis surroundings model (Module 20) are: a radar, video, ultrasonic, lidar, IR and/or another (active) optical surroundings sensor (Module 12). A piece of information, which is transmitted via telemetry (mobile radio network, WLAN, etc.) from the infrastructure (Car-to-X or Infrastructure-to-Car communication), from another road user (Car-to-Car communication), or from a traffic service to the ego-vehicle (Modules 14, 18). A location-relevant piece of information, which arises, for example, from navigation map data (determination of a position using, for example GPS, and stored information about accident risks in the map data) (Module 16). A vehicle variable of the ego-vehicle, for example, speed, external temperature, danger of potential of icy conditions ascertained from low traction, diagnostic states of components, movement profiles, etc.

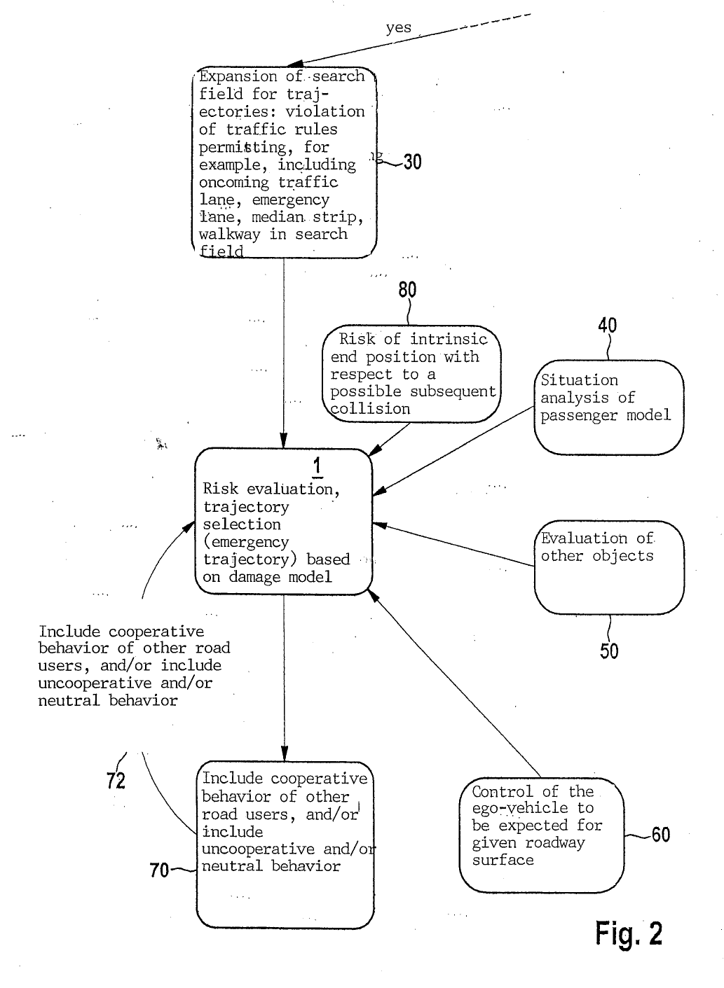

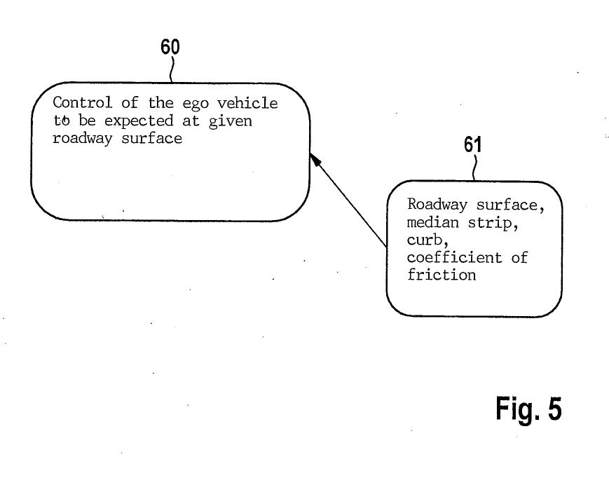

Chronologically after the detection of an imminent collision, the assistance system and/or the automatic driving function expands a search field for an emergency trajectory (Module 30, FIG. 2) to be selected, for example by allowing violations of the traffic rules, such as an evasion into an oncoming lane, an emergency lane, a median strip, a walkway, etc. (FIG. 5, Module 61, see below). This means that locations of this type otherwise forbidden to the ego-vehicle may be traversed in the exceptional situation of the imminent collision or used in order to prevent the collision. This is of course only possible if there is no threat of physical injury (other person and/or passenger of the ego-vehicle) and, where applicable, no excessive property damage. If there is no threat of physical injury, then damage to the ego-vehicle may be taken into consideration, for example, if thereby physical injury to potential other parties in the accident or otherwise higher property damage may be avoided.

Within the scope of a risk evaluation, a selection of an emergency trajectory for the ego-vehicle then takes place using the assistance system (Module 1). Module 1 hereby possesses the information of Module 30 or additionally the input data thereof and, if necessary, the information from Module 10 and/or Modules 12, 14, 16, 18 and also the vehicle variables. Furthermore, additional information for the decision basis is accessible to Module 1 through a situation analysis within the scope of a passenger model (Module 40), through an evaluation of the other objects (Module 50), a control of the ego-vehicle to be expected at a given roadway surface or other exterior parameters (Module 60).

Furthermore, Module 1 may consider a risk of an intrinsic end position following successful negotiation of an emergency trajectory with regard to a possible resulting collision (Module 80). In addition, a targeted influence of or warning to other road users may be carried out by Module 1 via, for example, honking, blinkers, headlights, brake lights, etc. (Module 70). During an interaction of Module 70 with Module 1, a cooperative, uncooperative, and/or neutral behavior of other road users may be included in the basis for decision making of Module 1 (Pos. 72).

Possible components for the situation analysis within the scope of the passenger model (Module 40) based, for example, on a status of the passengers (Module 42) are: a passenger compartment camera (passenger compartment sensor system, Module 422) for determining a position of a passenger (in particular object oriented programming states) or for detecting objects which may limit a function of restraint systems. Video, radar, ultrasonic, IR sensor systems for footwell monitoring in order to detect a position of the feet of the vehicle driver (for example, feet in front of the pedals, or “lifted up”) (Module 422). Video, radar, ultrasonic, IR sensor systems for monitoring hands in order to detect a position of the hands and arms of the vehicle driver (for example, hands on the steering wheel) (Module 422).

Furthermore, a seat occupancy detection (occupancy detection, weight detection, seat mats, capacitive sensors, child seat detection, for example Isofix) (Module 421). A position setting of the vehicle seats (via path sensors and movement detection of the servomotors) (Module 424). A belted-in state using a classic seat belt buckle sensor system and/or, if necessary, camera-based monitoring of an electromotor-driven retractor/belt motor (Module 423). An object identification using RFID, WLAN, or plug connections in order to check the plausibility of objects detected by the camera and, if necessary, to classify whether this object represents a hazard potential or not.

In addition: a position detection of other vehicle components located in the passenger compartment, for example, pivotable displays, keypads, trays (for food), steering wheel. A general sensor system related to individual safety for determining age, weight, gender, and mass distribution of the vehicle driver. A measurement of a degree of distraction of a passenger based on interaction with other people within or outside the ego-vehicle with the aid of analysis of speech characteristics of the vehicle driver (agitation, etc.), for example to use for threshold adjustment.

Possible criteria for the evaluation of other objects (Module 50) are: estimated time duration until the collision (time to collision) (Module 51); information, for example regarding structure, rigidity, mass, deformation zone, etc. (Module 52), which are transmitted, for example, via a Car-to-Car or an Infrastructure-to-Car communication (Module 521); offset (Module 54); object dimension (Module 55); relative speed (Module 53); crash probability, etc.

Possible criteria for a selection of a roadway and/or a control of the ego-vehicle to be expected (Module 60) are: use of prior knowledge, for example, frequency of use of traffic lanes, preference for traffic lanes in one's own driving direction (for example, using the emergency lane rather than an opposite traffic lane), etc. During a selection of another roadway surface, for example, a median strip, an approach angle and possible lateral accelerations at the present speed are to be considered so that a vehicle rollover may be prevented; likewise, when driving up onto curbs. Consider information about possible wetness/slickness using a rain/temperature sensor and use of previous knowledge regarding traction (μ estimator, Module 61).

Possible criteria for influencing other road users (Module 70) are: (constant) honking in order to induce a possible colliding vehicle to evade; honking for increased attention; flashing blinkers in order to indicate an intended emergency trajectory to the possible collision opponent; flashing lights, brake lights, etc. A risk evaluation in Module 1 results from a concatenation of a crash probability with a maximum possible severity of injury under consideration of the passenger model (Module 40) and under consideration, if necessary, of other road users with the following individual criteria and the goal of keeping a maximum possible severity of injury of all participants as low as possible.

Possible criteria for executing a risk evaluation (Module 1) are: an estimation of an energy reduction (integrating relative speed and object mass), if possible across time, because a lower energy reduction correlates with lower severity of injuries. Trajectories with greater time durations up to the collision initially have a lower probability of collision, since a situation may change in the time up to the collision and new alternative actions may arise. An offset with regard to an imminent collision; low offsets, which in the case of a crash would result in sliding may be used over typically possible offset collisions (for example, 40% overlap). Estimation of the severity of a possible collision. Integration of structure, rigidity, mass, relative speed, deformation zone, etc. of the possible collision opponent.

Furthermore: trajectories with higher vehicle control may be used. In case a collision is unavoidable, then influencing of the emergency trajectory away from a vehicle passenger cell or at least away from occupied seats, for example, in the case of an imminent lateral collision, do not steer at a vehicle door, but instead at a wheel housing. Integration of a risk of the end position following a first collision with regard to possible subsequent collisions (observe the subsequent traffic, frequency of use of the driving route, etc.). Integration of the situation analysis of the passenger model (Module 40) and adjusting a restraint system with regard to individual safety. Assumption that cooperative behavior of other road users, in particular after a targeted influence, is more probable than uncooperative behavior.

Examples for emergency trajectories according to the present invention are stated in the following. In one case, it is possible to avoid being involved in an accident that has just occurred, for example, in a rear-end accident occurring ahead, by evasion onto, for example, an emergency lane or a median strip. Furthermore, it is possible to select an emergency trajectory in such a way that, for example, the ego-vehicle remains stopped at a green light at an intersection (only temporal movement in the reference system) while an accident takes place in the intersection ahead of the vehicle. In a similar situation, the emergency trajectory may be selected in such a way that, for example, the ego-vehicle enters the intersection to the right against a red light, in the case that another vehicle is approaching too fast from the rear and would cause an accident with the ego-vehicle if the ego-vehicle did not move from its position.

What is claimed is:

1. A method for ascertaining at least one emergency trajectory of an ego-vehicle using at least one of an assistance system, a driver assistance system of the ego-vehicle, and an automatic driving function, the method comprising:
ascertaining, upon detection of an imminent collision of the ego-vehicle, the at least one emergency trajectory of the ego-vehicle by the assistance system or the automatic driving function under consideration of at least one other trajectory of at least one other object which is different from the ego-vehicle.

2. The method of claim 1, wherein the at least one emergency trajectory is, if necessary, successively ascertained from an array of emergency trajectories or an emergency trajectory space of the ego-vehicle, and/or the at least one other trajectory is ascertained from an array of other trajectories or another trajectory space of the relevant other object, or the at least one other trajectory is an array of other trajectories or another trajectory space.

3. The method of claim 1, wherein, in the case of an unavoidable collision, the emergency trajectory is ascertained so that firstly probably no or only minor physical injuries occur and only secondly probably no or only minor property damage occurs.

4. The method of claim 1, wherein temporally during or chronologically after the ascertainment of the at least one emergency trajectory, an emergency trajectory is selected by the assistance system or the automatic driving function and output to the vehicle driver and/or an automatic driving module of the automatic driving function.

5. The method of claim 1, wherein the imminent collision of the ego-vehicle is detectable by a situation analysis within the scope of a surroundings model of the ego-vehicle, the surroundings model considering in particular a piece of information from a surroundings sensor system of the ego-vehicle, a Car-to-X communication of the ego-vehicle, navigation and/or specific map data of the ego-vehicle, and/or a traffic report.

6. The method of claim 1, wherein the emergency trajectory is ascertained by performing at least one of the following:
considering data for the surroundings model and/or data from the situation analysis within the scope of the surroundings model;
performing an evaluation of the data from the other object or the other objects;
performing a situation analysis within the scope of a passenger model, by use of which potential dangers are considered for a passenger;
considering a control of the ego-vehicle to be expected during the presently prevailing conditions;
considering a guaranteed and/or estimated behavior of another road user;
considering a risk of an end position of the ego-vehicle to be expected chronologically after the traveled emergency trajectory; and
using, during ascertainment of the at least one emergency trajectory, an expanded search field for the emergency trajectory.

7. The method of claim 1, wherein at least one of the following is satisfied:
the assistance system is, with regard to the ego- vehicle, an external assistance system, in particular an infrastructure-based assistance system;
the other object is another vehicle, another road user, or a stationary yet moveable, or fixed other object in the surroundings of the ego-vehicle;
a warning is output to the other road user about the imminent collision;
the warning is output visually, acoustically, and/or via radio; and
a piece of country specific information is considered by the method.

8. A method for providing partially automated or automated driving of an ego-vehicle, upon detection of an imminent collision of the ego-vehicle, the method comprising:
outputting a warning to a vehicle driver of the ego-vehicle by an assistance system or an automatic driving function, an emergency trajectory being output as a trajectory to be traveled, and/or an intervention being carried out in/on the ego-vehicle by the assistance system or the automatic driving function of the ego-vehicle so that the ego-vehicle is forced to travel or to follow an emergency trajectory;
wherein the emergency trajectory of the ego-vehicle is performed using at least one of the assistance system and the automatic driving function, by ascertaining, upon detection of an imminent collision of the ego-vehicle, the at least one emergency trajectory of the ego-vehicle by the assistance system or the automatic driving function under consideration of at least one other trajectory of at least one other object which is different from the ego-vehicle.

9. The method of claim 1, wherein at least one of the following is satisfied:
the emergency trajectory is haptically, visually, and/or acoustically output to the vehicle driver of the ego-vehicle;
the intervention on the ego-vehicle is an intervention on/in the chassis, in particular a steering, brake, and/or damper intervention;
the intervention on the ego-vehicle is an intervention on/in the drivetrain, in particular an engine and/or transmission intervention;
the intervention on the ego-vehicle is confirmable by the vehicle driver and/or negate-able by the vehicle driver;
chronologically after traveling the emergency trajectory, the ego-vehicle is partially automated and/or automatically brought into a safe position by the vehicle driver;
chronologically after travelling the emergency trajectory, a prompt for taking over the vehicle is issued to the vehicle driver of the ego-vehicle; and
a successfully negotiated emergency trajectory is a traveled evasion trajectory, wherein an accident occurred without a substantial and/or original involvement of the ego-vehicle.

10. A computer readable medium having a computer program, which is executable by a processor, comprising:
a program code arrangement having program code for ascertaining at least one emergency trajectory of an ego-vehicle using at least one of an assistance system, a driver assistance system of the ego-vehicle, and an automatic driving function, by performing the following:
ascertaining, upon detection of an imminent collision of the ego-vehicle, the at least one emergency trajectory of the ego-vehicle by the assistance system or the automatic driving function under consideration of at least one other trajectory of at least one other object which is different from the ego-vehicle.

11. The computer readable medium of claim 10, wherein the at least one emergency trajectory is, if necessary, successively ascertained from an array of emergency trajectories or an emergency trajectory space of the ego-vehicle, and/or the at least one other trajectory is ascertained from an array of other trajectories or another trajectory space of the relevant other object, or the at least one other trajectory is an array of other trajectories or another trajectory space.

12. A safety device, having a driver assistance system and/or an automatic driving function, for a vehicle, comprising:
a safety device arrangement configured for ascertaining at least one emergency trajectory of an ego-vehicle using at least one of an assistance system, a driver assistance system of the ego-vehicle, and an automatic driving function, by performing the following:
ascertaining, upon detection of an imminent collision of the ego-vehicle, the at least one emergency trajectory of the ego-vehicle by the assistance system or the automatic driving function under consideration of at least one other trajectory of at least one other object which is different from the ego-vehicle.

13. The safety device of claim 12, wherein the driver assistance system and/or the automatic driving function, includes a driver assistance system, a chassis unit, in particular a steering, brake, and/or damper controller/regulator, and/or a drivetrain unit, in particular an engine and/or transmission controller/regulator, for the vehicle, in particular a motor vehicle.

14. The method of claim 1, wherein temporally during or chronologically after the ascertainment of the at least one emergency trajectory, an emergency trajectory is selected by the assistance system or the automatic driving function and output to the vehicle driver and/or an automatic driving module of the automatic driving function, the selected emergency trajectory being particularly output as an established emergency trajectory, or the emergency trajectory being particularly changed during traveling of the emergency trajectory, corrected by segments, successively supplemented, and/or newly calculated.
